(19) United States
(12) Patent Application Publication
(10) Pub. No.: US 2007/0113600 A1
(43) Pub. Date: May 24, 2007

(54) Locking mechanism

(76) Inventors: Jesse A. Marcelle, Muskego, WI (US); Glenn Meekma, Menomonee, WI (US)

Correspondence Address: CALFEE, HALTER & GRISWOLD LLP, 1400 MCDONALD INVESTMENT CENTER, 800 SUPERIOR AVENUE, CLEVELAND, OH, 44114, US

(21) Appl. No.: 11/347,615

(22) Filed: Feb. 3, 2006

Related U.S. Application Data
(60) Provisional application No. 60/738,544, filed on Nov. 21, 2005.

(51) Int. Cl. E05B 37/06

(52) U.S. Cl. 70/29

(57) ABSTRACT

This invention and disclosure are directed to apparatus and methods for securing a lock from being unlocked by an unauthorized method or mechanism. Apparatus and methods are disclosed herein regarding positioning of shackles and latch members of locking mechanisms. In one embodiment of the invention apparatus and methods incorporate a spring to bias a shackle within a lock. The biasing of the shackle positions a latch member in such a manner to offer greater security against unauthorized opening of a lock.

### CROSS-REFERENCE TO RELATED APPLICATIONS

This non-provisional application claims the benefit of U.S. Provisional Patent Application No. 60/738,544, entitled “Locking Mechanism,” filed Nov. 21, 2005.

### FIELD OF THE INVENTION

This invention relates generally to arrangements of locking mechanisms within locks and relates specifically to apparatus and methods for positioning latches and shackles within locks.

### BACKGROUND OF THE INVENTION

Locks and other securing devices are designed and used to secure all types of objects and spaces against unauthorized access. Locks are commonly used to secure containers, such as lock boxes, lockers, and cabinets, or areas, such as rooms, buildings, and fenced in yards. All locks are designed to be resistant to unlocking without an authorized key, combination, code, or other such authorizing mechanism. It is desirable to develop improvements to existing apparatus and methods for preventing unauthorized entry into a container, area, and the like secured by a lock.

### SUMMARY OF INVENTION

This invention and disclosure are directed to apparatus and methods for securing a lock from being unlocked by an unauthorized method or mechanism. Apparatus and methods are disclosed herein regarding positioning of shackles and latch members of locking mechanisms.

An embodiment of the invention provides for a lock comprising a lock housing, a shackle, a locking mechanism, and a shackle biasing member. The shackle is moveably coupled to the lock housing and includes a recess. The lock mechanism is assembled in the housing and includes a latch member and a stop. The latch member is selectively engageable by a surface defined by the recess. The stop member selectively limits the movement of the latch member. The shackle biasing member biases the shackle in a first direction such that the surface defined by the recess engages the latch member to inhibit movement of the latch member with respect to the shackle and lack body and prohibit movement of the shackle in the first direction with respect to the lock body when the shackle is in the locked position.

### DESCRIPTION OF THE DRAWINGS

In the accompanying drawings, which are incorporated in and constitute a part of this specification, embodiments of the invention are illustrated, which, together with a general description of the invention given above, and the detailed description given below serve to illustrate the principles of this invention. The drawings and detailed description are not intended to and do not limit the scope of the invention or the claims in any way. Instead, the drawings and detailed description only describe embodiments of the invention and other embodiments of the invention not described herein are encompassed by the claims.

FIG. 1 is a perspective view of a lock constructed in accordance with an embodiment of the present invention including a shackle spring and showing an internal locking mechanism;

FIG. 2 is a cross-sectional view of the lock of FIG. 1, showing the lock in a locked and latched state;

FIG. 2A is a detailed view of the area designated by a dashed circle in FIG. 2;

FIG. 3 is a cross-sectional view of the lock of FIG. 1, showing the lock in an unlocked and latched state;

FIG. 4 is a cross-sectional view of the lock of FIG. 1, showing the lock in an unlocked and unlatched state;

FIG. 5 is a cross-sectional view of the lock of FIG. 1, showing the lock in a locked and unlatched state;

FIG. 6 is a cross-sectional view of a lock without a shackle spring, showing the lock in a locked and unlatched state; and

FIG. 7 is a cross-sectional view of the lock of FIG. 6, showing the lock in a locked and latched state.

### DETAILED DESCRIPTION

This Detailed Description of the Invention merely describes embodiments of the invention and is not intended to limit the scope of the claims in any way. Indeed, the invention as described by the claims is broader than and unlimited by the disclosed embodiments and the language used in this specification, and the terms used have their full ordinary meaning.

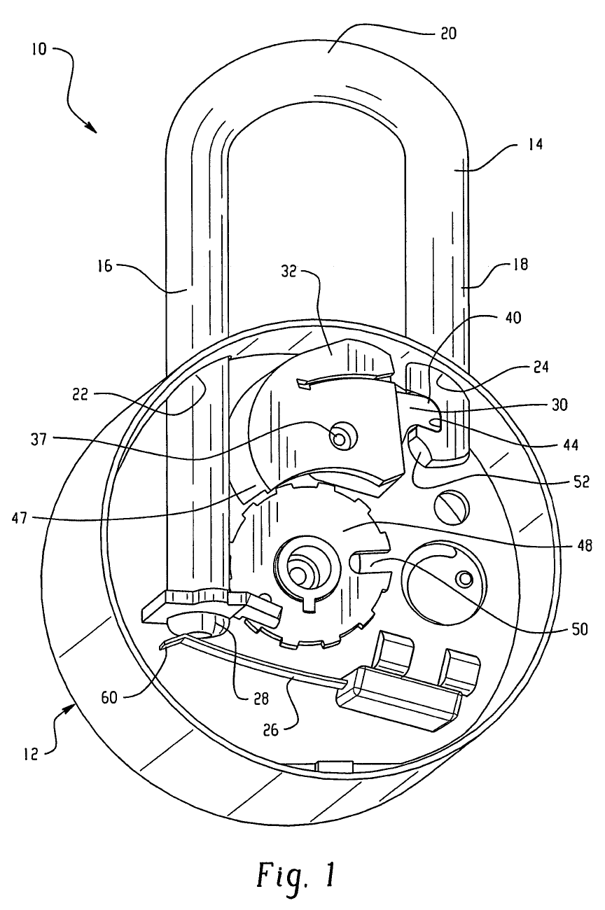

FIGS. 1-5 illustrate an embodiment of a lock and locking mechanism for positioning a shackle and a latch member. While the illustration is directed at a specific combination lock, the features of the present invention could be applied to other locks, such as for example padlocks, illuminating combination locks, door locks, locker locks, and keyed locks.

FIG. 1 illustrates a perspective view of a lock 10 with internal components of the lock 10 shown. The lock 10 as shown has a lock body or lock housing 12 and a shackle 14. The shackle 14 is generally u-shaped and includes a long leg 16 and a short leg 18 joined by a connector portion 20. The shackle is coupled to the lock body 12 such that the shackle 14 is moveable with respect to the lock body 12. This shackle movement is generally upward or downward, with respect to FIG. 1.

Throughout the range of motion of the shackle 14, the long leg 16 remains partially located within the body 12. The long leg 16 passes into the body 12 through a long leg aperture 22. The short leg 18 is selectively partially located within the body 12. As the shackle 14 moves upward, with respect to FIG. 1, the full length of the short leg 18 may exit the body 12. When the full length of the short leg 18 is located outside the body 12, the shackle 14 can be passed through a hasp or other such structure to secure a container, area, or the like. The short leg 18 enters and exits the body 12 through a short leg aperture 24.

Although the embodiment of FIG. 1 shows a shackle 14 where the long leg 16 remains at least partially within the body 12 throughout its full range of motion, it should be understood that a shackle may be arranged such that the shackle fully exits the body upon movement of the shackle with respect to the body.

As will be described in greater detail below, the lock 10 includes a shackle spring 26. The shackle spring 26 is selectively in contact with a bottom surface 28 of the long leg 16 of the shackle 14. When the shackle spring 26 is in contact with the shackle 14, the spring 26 biases the shackle 14 in an upward direction, with respect to FIG. 1. When the lock 10 is in a locked state and the shackle 14 is latched, as shown in FIG. 1, the biasing force of the shackle spring 26 forces the shackle 14 upward until the shackle 14 can no longer move upwards with respect to the body 12.

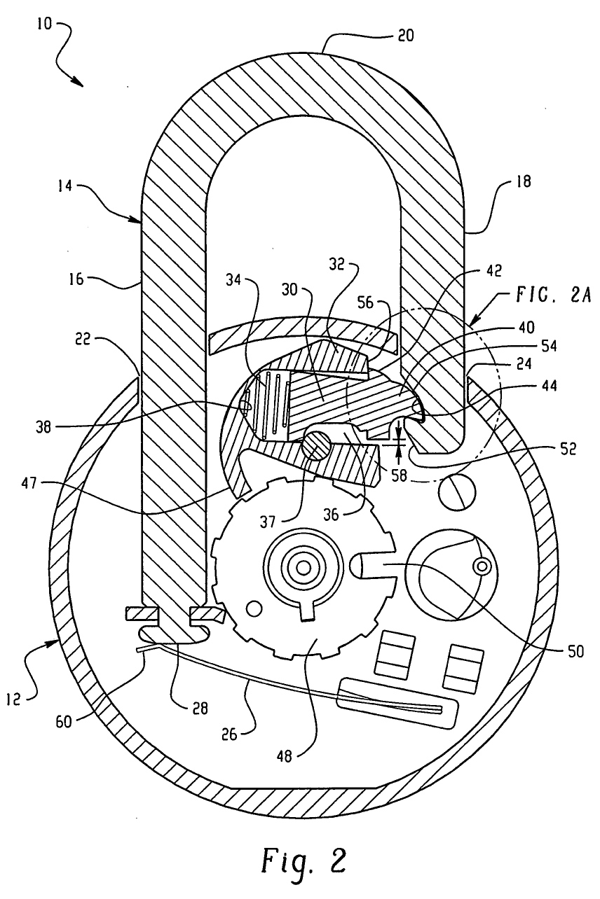

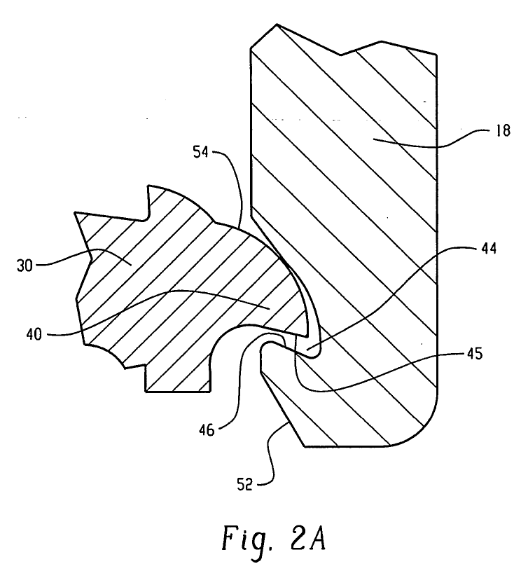

The lock 10 typically has a locked state and an unlocked state. In the locked state, a portion of the short leg 18 of the shackle 14 is located within the body 12 and the short leg 18 is secured in the body 12 by a locking mechanism. As best illustrated by FIG. 2, the locking mechanism includes a latch member 30, a latch housing 32, and a latch spring 34. The latch member 30 is at least partially positioned within a chamber 36 defined by the housing 32. The latch spring 34 is positioned between an inner surface 38 of the chamber 36 and the latch member 30. The latch member 30 is arranged to be moveable with respect to the chamber 32. The latch spring 34 is a compression spring and when the spring 34 is compressed, it biases the latch member 30 and encourages the latch member 30 to move out of the chamber 36 in a direction towards the short leg 18. The latch housing 32 is pivotally coupled to the body 12 at a pivot point 37. A spring or other biasing member (not shown) is coupled to the housing 32 and biases the housing 32 in a clockwise direction, with respect to FIG. 2.

The latch member 30 includes a latching portion 40 that engages with the short leg 18 to secure the short leg 18 within the body 12. The latch member 30 also includes a protrusion 42. The protrusion 42, to be discussed in detail below, selectively limits the movement of the latch member 30 with respect to the latch housing 32 and the shackle 14.

FIGS. 1 and 2 show the lock 10 in a locked state. As shown, the latch member 30 secures the short leg 18 within the body 12 such that movement of the shackle 14 with respect to the body 12 is resisted. The short leg 18 defines a recess 44 that serves as a catch for the latching portion 40 of the latch member 30. As best seen in FIG. 2A, the latching portion 40 is positioned in the recess 44 such that a generally flat surface 45 of the latching portion 40 engages a surface 46 of the recess 44. This engagement is such that the shackle 14 cannot be moved upward without displacing the latch member 30. Since the latch member 30 is positioned within the latch housing 32, which is pivotally coupled to the body 12, the latch member 30 can be displaced by counterclockwise rotation of the latch housing 32.

Referring again to FIGS. 1 and 2, when the lock 10 is in the locked state, counterclockwise rotation of the latch housing 32 is resisted by the arrangement of components within the lock 10. As shown, the housing 32 includes a tail portion 47. The tail portion 47 is positioned proximate to a combination cam 48, which includes a groove 50. Any combination cam known in the art can be used in the practice of this invention. When the lock 10 is in a locked state, the groove 50 is positioned to be out of alignment with the tail 47. When the shackle 14 or body 12 is manually pulled and the shackle 14 attempts to displace the latch member 30, the tail 47 of the housing 32 comes into contact with the cam 48 and counterclockwise rotation of the housing 32 is resisted. Thus, the short leg 18 remains secured within the body 12.

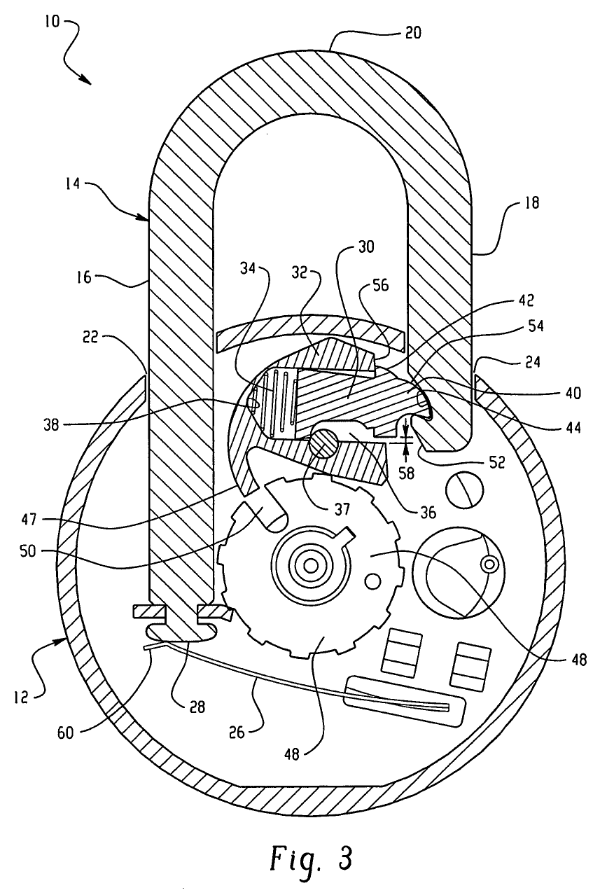

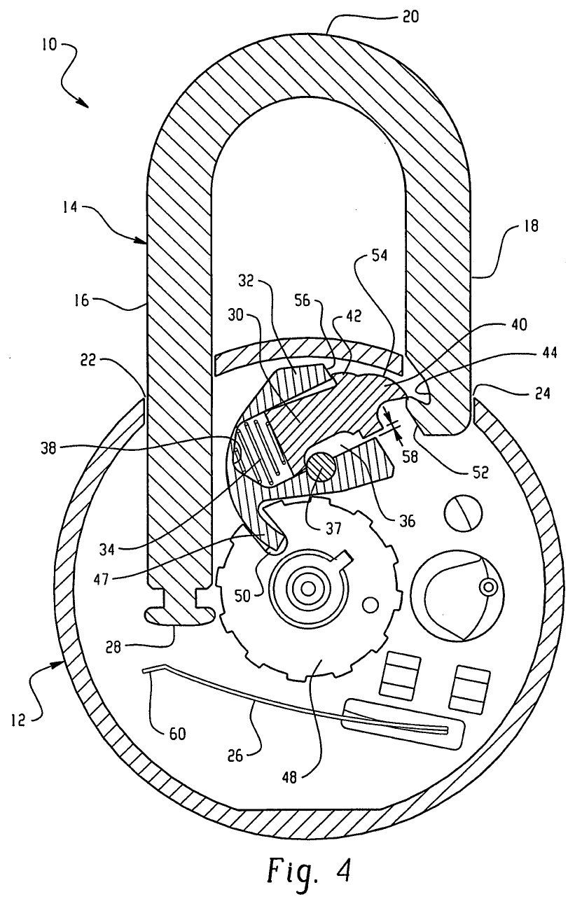

FIGS. 3 and 4 illustrate the lock 10 in an unlocked state after an operator has properly rotated a combination dial mechanically attached to the cam 48. In FIG. 3, the lock 10 is unlocked and the short leg 18 remains within the lock body 12. In FIG. 4, the shackle 14 is in the process of moving upward to move the short leg 18 out of the body 12 and open the lock. As shown in FIG. 3, when the lock 10 is in the unlocked state the groove 50 in the cam 48 is aligned with the tail 47 of the latch housing 32. As shown in FIG. 4, as the shackle 14 moves upward, the engagement of the recess 44 and the latching portion 40 causes the latch member 30 to be displaced and the latch housing 32 rotates counterclockwise. Because the groove 50 is aligned with the tail 47, the tail 47 can enter the groove 50 to accommodate this counterclockwise rotation. Thus, the short leg 18 displaces the latch member 30 and can exit the body 12, effectively opening the lock 10. Once the short leg 18 exits the body and is no longer in contact with the latch member 30, the spring or other biasing member coupled to the housing 32 urges the housing 32 to rotate in the clockwise direction and return to approximately the position shown in FIG. 3.

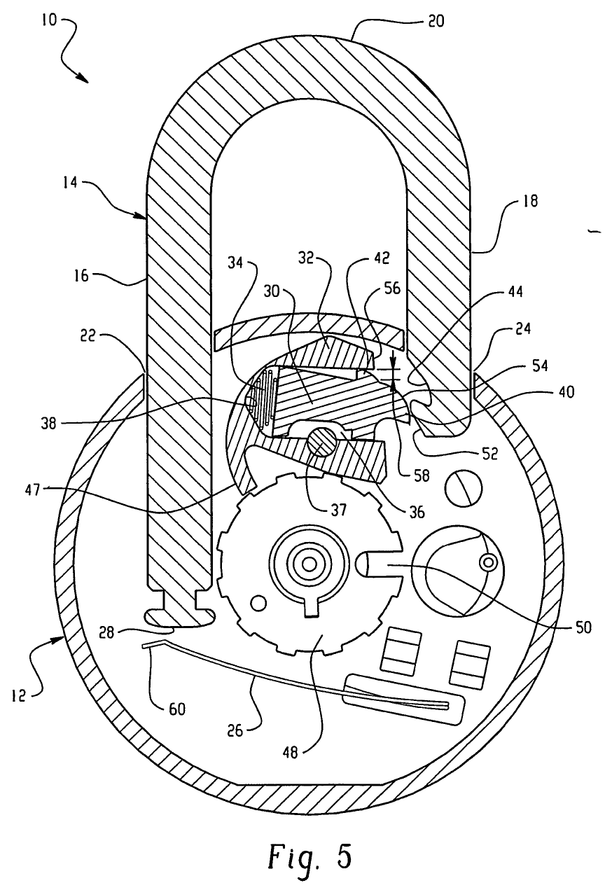

When the full length of the short leg 18 is outside the lock body 12, the lock 10 can be locked by moving the short leg 18 back into the body 12. As shown in FIG. 5, the combination cam 48 is positioned so that the groove 50 is not aligned with the tail portion 47 of the latch housing 32. As the shackle 14 is moves downward and back into the body 12, an angled surface 52 of the short leg 18 contacts a matching angled surface 54 of the latching portion 40. The contact of the angled surfaces 52 and 54 causes the latch member 30 to retract into the chamber 36. As the latch member 30 retracts into the chamber 36, the latch spring 34 compresses. The movement of the latch member 30 allows for the short leg 18 to pass by the latch member 30 and be located in a position to be secured. Once the short leg 18 passes the latch member 30, the compression of the latch spring 34 biases the latch member 30 towards the short leg 18 and the latch portion 40 moves into engagement with the recess 44. This engagement secures the short leg 18 within the body 12 and locks the lock 10.

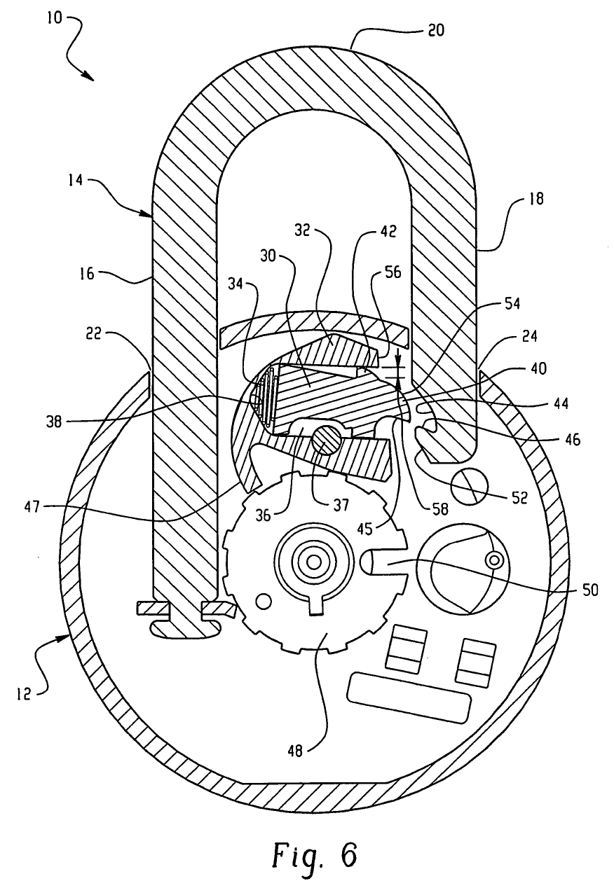

Referring again to FIG. 5, if the latch member 30 were not able to move into the chamber 36, the short leg 18 could not pass by the latch member 30 and the lock 10 could not be closed and locked. The latch member 30 and the chamber 36 are sized such that the latch member 30, including the protrusion 42, can be accommodated within the chamber 36. However, while the lock 10 is in a locked state with the short leg 18 secured within the body 12, if the latch member 30 is allowed to substantially move into the chamber 36, the lock 10 could be opened without placing the lock 10 in an unlocked state. Referring to FIG. 6, the recess 44 of the short leg 18 is located within the lock body 12 at a position where the leg 18 is normally secured. However, the latch member 30, including the protrusion 42, is retracted an increased distance into the chamber 36. In this arrangement, the shackle 14 can be moved upward and the lock 10 opened, even though the lock 10 is in a locked state. As described above, when compressed the latch spring 34 biases the latch member 30 towards the short leg 18; however, under certain conditions, the latching portion 40 may still not engage with the recess 44 even though the leg 18 is in position to be secured. One method of at least temporarily creating such a condition is to apply an impact on the outside of the body 12. If an impact is properly directed to the side of the body 12, the inertia of the latch member 30 or other components could cause the latch spring 34 to compress and the latch member 30 to retract into the chamber. This could allow unauthorized opening of the lock 10.

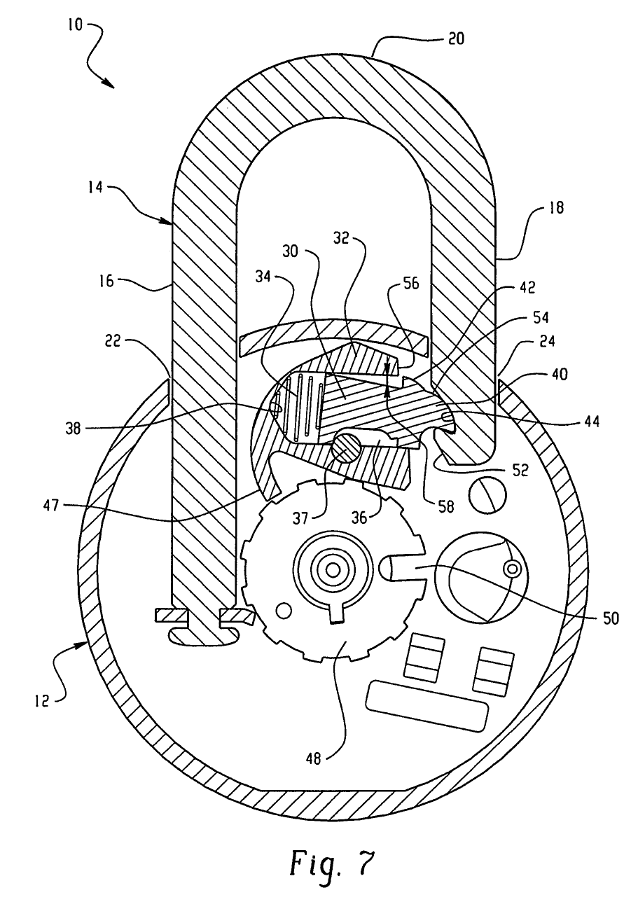

Such conditions are normally prevented by the protrusion 42 on the latch member 30. As best shown in FIG. 2, the protrusion 42 is designed to engage the latch housing 32, with a surface 56 of the housing 32 acting as a mechanical stop. When the protrusion 42 is positioned proximate to the housing surface 56, the engagement of the protrusion 42 and the housing surface 56 prevents the latch member 30 from substantially retracting into the chamber 36 and the latching portion 40 from disengaging from the recess 44. Thus, even a properly directed impact on the side of the body 12 would not cause the spring 34 to compress and the latch member 30 to retract into the chamber 36, preventing the security of the lock 10 from being jeopardized. However, as shown in FIG. 7, the latch member 30 can be positioned such that the protrusion 42 is not positioned proximate to the housing surface 56 and will not engage with the housing surface 56 when the latch member 30 is urged to move further into the chamber 36. As previously described, the latch member 30 and chamber 36 are sized such that the latch member 30, including the protrusion 42, can be accommodated in the chamber 36. When the protrusion 42 is outside of the chamber 36, this sizing ensures that there will be a gap 58 between the latch member 30 and the chamber 36. As shown in FIG. 2, the gap 58 can be below the latch member 30 or, as shown in FIG. 7, the gap 58 can be above the latch member 30, during operation of the lock 10.

This gap 58 is necessary for the lock 10 to perform properly. The gap 58 allows for some clearance room between the latch member 30 and the chamber 36. This clearance room is needed so that the protrusion 42 can be selectively positioned proximate to the housing surface 56 to engage with the housing surface 56 or selectively positioned such that the latch member 30, along with the protrusion 42, can be accommodated in the chamber 36. As described above and shown in FIG. 2, when the lock 10 is secured, positioning the protrusion 42 proximate to the housing surface 56 to engage with the housing surface 56 can restrict unauthorized opening of the lock 10. Also as described above and shown in FIG. 5, when the short leg 18 moves into the lock body 12, the latch member 30 and the protrusion 42 retract into the chamber 30 to allow the short leg 18 to pass by the latch member 30 and be secured within the body 12.

As shown in FIGS. 6 and 7, when the short leg 18 located in the lock body 12 and the gap 58 is above the latch member 30, the lock 10 is susceptible to unauthorized opening. Thus, maintaining the gap 58 below the latch member 30 can reduce the possibility of unauthorized opening of the lock 10. One method of encouraging the latch member 30 to be positioned so that the gap 58 is located below the latch member 30 is through the inclusion of the shackle spring 26. As discussed above and shown in FIGS. 1 and 2, a shackle spring 26 is placed in contact with the bottom surface 28 of the long leg 16 of the shackle 14. The spring 26 is arranged to apply a force to the shackle 14 in the locked state that biases the shackle 14 upwards, with respect to FIGS. 1 and 2, until the shackle 14 cannot move upwards with respect to the body 12. This force is transferred from the recess 44 in the short leg 18 to the latching portion 40 of the latch member 30. The transferred force encourages the latch member 30 upward, leaving the gap 58 below the latch member 30 (as best seen in FIG. 2). In this arrangement, the protrusion 42 is positioned proximate to the housing surface 56 such that the protrusion 42 will engage the housing surface 56 to inhibit the movement of the latch member 30 if the latch member 30 attempts to retract into the chamber 36. The spring force of the shackle spring 26 can be designed such that the latch member 30 is pressed against an inner surface of the chamber 36. In this arrangement, in addition to the protrusion 42 inhibiting movement of the latch member 30, frictional forces between the latch member 30 and the inner surface of the chamber 36 inhibit movement of the latch member 30 with respect to the chamber 36 and the shackle 14.

The embodiment illustrated in FIGS. 1-5 shows the shackle spring 26 as a lever spring. It should be understood that a variety of spring and other mechanisms could be used to bias the shackle 14 in the upward direction, with respect to FIG. 1. These mechanisms include, but are not limited to, coil springs arranged in either compression or extension, torsion springs, leaf springs, or any other mechanism that applies a force to the shackle such that the latch member 30 is positioned to inhibit the latch member 30 from retracting into the chamber 36 when the lock 10 is in a locked state and the short leg 18 is secured. Additionally, the shackle spring 26 is shown in direct contact with the long leg 16 of the shackle 14. It should be understood that a spring could be in contact with the short leg 18, any other part of a shackle, or in contact with the latch member. Further, the contact between a spring and the shackle could be indirect as well as direct.

Further, the shackle spring 26 has a bent end 60 at the point of contact with the long leg 16. This bent end 60 reduces the likelihood that the spring 26 will dig into the bottom surface 28 of the leg 18 and damage the long leg 16 of the shackle 14.

In one embodiment the range of motion of a shackle is approximately ⅝ inches. In this embodiment, a shackle spring remains in contact with the shackle for approximately ⅜ inches of this range of motion. In this arrangement, once the lock is placed in an unlocked state, the shackle has a tendency to spring or pop open due to the biasing force of the shackle spring. In other embodiments, a shackle spring may remain in contact with a shackle during the entire range of motion or may remain in contact for only a short distance of the range of motion.

Typically, gravitational forces are relied upon to pull the lock body 12 downward, with respect to the lock 10 shown in FIG. 7. Gravitational forces are typically large enough to cause the recess 44 to force the latch member 30 into a position where the gap 58 is below the latch member 30, as shown in FIG. 2. However, an arrangement where the gap 58 is above the latch member 30 when the short leg is secured, as shown in FIG. 7, can occur in a number of ways when a shackle spring 26 is not used.

One example of an arrangement that can cause the gap 58 to be situated above the latch member 30 is when the tolerances between the diameter of the short leg aperture 24 and the diameter of the short leg 16 are very small. One technique of opening a lock without the proper authorization is to insert an object between the short leg and the short leg aperture and pry the short leg such that the recess moves away from the latch member. As the short leg is pried, the recess may disengage with the latching portion, which would leave the short leg unsecured and allow the lock to be opened. To combat this situation, the tolerances between the diameter of the short leg 18 and the diameter of the short leg aperture 24 can be tightened. This arrangement makes it more difficult to insert an object between the short leg 18 and aperture 24 by which to pry the short leg 18 and open the lock 10. The tolerances can be tight enough to cause a slight friction fit or interference fit between the short leg 18 and the aperture 24. Interference between the short leg 18 and the aperture 24 can also be caused if the leg 18 is slightly bent. This friction fit can resist the gravitational forces that normally urge the lock body 12 downward and, thus, the body 12 can remain positioned higher than normal and cause the latch member 30 to be positioned such that the protrusion 42 will not engage the housing surface 56 to stop the latch member 30 from retracting into the chamber 36.

The force that the shackle spring 26 placed on the long leg 16 of the shackle 14 may be designed large enough to overcome any forces generated by a friction or interference fit between the short leg 18 and the short leg aperture 24. Other examples of arrangements that can lead to the gap 58 being located above the latch member 30 are build-ups of corrosion or other substances around the short leg or long leg apertures 22 and 24, bending or other deformations of the shackle 14, and ice or moisture gathering on lock components. The force of the shackle spring 26 is designed to account for these and other examples to maintain the gap 58 below the latch member 30 when the lock 10 is in a locked state and the short leg 16 is secured in the lock body 12.

While various aspects of the invention are described and illustrated herein as embodied in combination in the exemplary embodiments, these various aspects may be realized in many alternative embodiments not shown, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however; such values and ranges are not to be construed in a limiting sense and are intended to be critical values or ranges only if so expressly stated.

We claim:

1. A lock comprising:
a. a lock housing;
b. a shackle moveably coupled to the lock housing, the shackle defining a recess;
c. a locking mechanism assembled in the lock housing comprising:
i. a latch member selectively engageable with a surface defined by the recess; and
ii. a stop member that limits movement of the latch member; and
d. a shackle biasing member selectively biasing the shackle in a first direction such that the surface defined by the recess engages the latch member to inhibit movement of the latch member with respect to the shackle.

2. The lock of claim 1 wherein the latch member is selectively positioned proximate to the stop member.

3. The lock of claim 2 wherein when the latch member is positioned proximate to the stop member, the latch member engages the stop member when the latch member is urged in a second direction and the engagement of the latch member and the stop member inhibits movement of the latch member in the second direction.

4. The lock of claim 2 wherein when the latch member is not positioned proximate to the stop member, the stop member does not inhibit movement of the latch member in a second direction.

5. The lock of claim 1 wherein the latching member includes a protrusion; further wherein, the protrusion is selectively positioned proximate to the stop member.

6. The lock mechanism of claim 5 wherein when the protrusion is positioned proximate to the stop member, the protrusion engages the stop member when the latch member is urged in a second direction and the engagement of the protrusion and the stop member inhibits movement of the latch member in the second direction.

7. The lock of claim 5 wherein when the protrusion is not positioned proximate to the stop member, the stop member does not inhibit movement of the latch member in a second direction.

8. A lock comprising:
a. a lock housing;
b. a shackle moveably coupled to the lock housing;
c. a locking mechanism assembled in the housing including a latch member; and
d. a shackle biasing member selectively biasing the shackle in a first direction such that the shackle selectively engages the latch member to inhibit movement of the latch member in a second direction.

9. The lock of claim 8 wherein when the lock is locked and the shackle is biased in the first direction to engage the latch member, the latch member is inhibited from moving in the second direction.

10. The lock of claim 8 wherein when the lock is unlocked, the latch member is not inhibited from moving in the second direction.

11. The lock of claim 8 wherein the shackle is moveable between an open position and a closed position.

12. The lock of claim 11 wherein when the lock is locked and the shackle is urged from the closed position towards the open position the latch member is inhibited from moving in the second direction.

13. The lock of claim 11 wherein the when the lock is locked and the shackle is moving from an open position to a closed position the latch member is not inhibited from moving in the second direction.

14. The lock of claim 11 wherein when the lock is unlocked and the shackle is moving from a closed position to an open position the latch member is not inhibited from moving in the second direction.

15. The lock of claim 11 wherein when the lock is unlocked and the shackle is moving from an open position to a closed position the latch member is not inhibited from moving in the second direction.

16. A lock comprising:
a. a lock housing;
b. a shackle moveably coupled to the lock housing;
c. a locking mechanism assembled in the lock housing comprising:
i. a latch member selectively engageable with the shackle; and
ii. a stop member that limits movement of the latch member; and
d. a shackle biasing member selectively biasing the shackle in a first direction such that the shackle engages the latch member to inhibit movement of the latch member with respect to the shackle.

17. The lock of claim 16 wherein the latch member is selectively positioned proximate to the stop member to inhibit movement of the latch member with respect to the shackle.

18. The lock of claim 17 wherein the latch member includes a protrusion; further wherein, the protrusion is selectively positioned proximate to the stop member to inhibit movement of the latch member with respect to the shackle.

19. A method for inhibiting movement of a latch member in a lock comprising the steps of:
a. biasing a shackle in a first direction;
b. engaging the shackle to the latch member to urge the latch member in the first direction; and
c. inhibiting the movement of the latch member with respect to the shackle.

20. The method of claim 19 further comprising the step of positioning the latch member proximate to a stop member.
